(19) United States
(12) Patent Application Publication
(10) Pub. No.: US 2013/0186189 A1
(43) Pub. Date: Jul. 25, 2013

(54) APPARATUS FOR DETERMINING A MOISTURE CONTENT OF A FLUID FLOWING THROUGH A PIPE LINE

(71) Applicant: Emerson Climate Technologies GmbH, Waiblingen (DE)

(72) Inventor: Christian Fuhrmann, Rommerskirchen (DE)

(73) Assignee: Emerson Climate Technologies GmbH, Waiblingen (DE)

(21) Appl. No.: 13/748,034

(22) Filed: Jan. 23, 2013

(30) Foreign Application Priority Data
Jan. 24, 2012 (DE) 102012001383.3

(51) Int. Cl. G01N 19/10

(52) U.S. Cl. CPC G01N 19/10
USPC 73/73

(57) ABSTRACT

The invention relates to an apparatus for determining the moisture content of a fluid flowing through a pipe line, having a housing with a sight glass arranged at a first side of the housing, a housing opening which allows an entry of the fluid into an inner housing space and a moisture indicator which is visible through the sight glass, wherein a dimension of the housing opening in at least one direction is smaller than a dimension of the sight glass in the same direction.

### CROSS-REFERENCE TO RELATED APPLICATIONS

This application claims the benefit of German Patent Application No. 102012001383.3, filed Jan. 24, 2012. The disclosure of the above application is incorporated herein by reference in its entirety.

### FIELD

The present invention relates to an apparatus for determining a moisture content of a fluid flowing through a pipe line, said apparatus having a housing defining an inner housing space, a sight glass arranged at a first side of the housing and a moisture indicator which is arranged in the inner housing space visible through the sight glass.

### BACKGROUND

Apparatus of this kind are generally known and are used in refrigeration machines, for example. Since the refrigerants used there are hygroscopic, the penetration of moisture into the refrigerant circuit is undesirable. The moisture content of the refrigerant, i.e. its water portion, is therefore monitored in refrigeration machines. For this purpose, a hygroscopic substance, e.g. common salt, is used as a moisture indicator whose color varies with the moisture content of the refrigerant.

A known apparatus of the initially named kind is thus integrated into a pipe line of a refrigeration machine such that sections of the pipe line adjoin opposite sides of the housing, i.e. such that the pipe line so-to-say passes through the housing and the refrigerant flows completely through the apparatus. The reading of the moisture indicator can be difficult with this apparatus, in particular when the moisture indicator has a dark coloring and thus only has a small contrast to the dark inner housing space.

It is the underlying object of the invention to provide an apparatus of the initially named kind which allows a better readability of the moisture indicator.

The object is satisfied by an apparatus having the features of claim 1.

### SUMMARY

The apparatus in accordance with the invention includes a housing which defines an inner housing space, a sight glass arranged at a first side of the housing, a housing opening which is arranged at a second side of the housing which is disposed opposite the first side and which allows an entry of the fluid flowing through the pipe line into the inner housing space and the apparatus includes a moisture indicator which is arrange in the inner housing space visible through the sight glass. A dimension of the housing opening is smaller in at least one direction than a dimension of the sight glass in the same direction.

In the apparatus in accordance with the invention, the pipe line does not pass through the housing, i.e. the inner housing space is not flowed through by the total fluid flowing through the pipe line, but the apparatus is rather so-to-say attached laterally to an outer side of the pipe line, with a communication between the inner housing space and the interior of the pipe line taking place via the housing opening arranged at the second side of the housing.

This results, on the one hand, in an improved flow of the fluid in the pipe line since the flow through the comparatively small housing opening is at least not substantially disturbed.

On the other hand, due to the arrangement of the apparatus provided in accordance with the invention at the pipe line and due to the special dimensioning of the housing opening in comparison with the sight glass, it is achieved that at least a portion of the second side of the housing, e.g. a rear wall of the housing, is located comparatively close to the moisture indicator and to the sight glass. A comparatively bright background is thereby formed by the second housing side and provides a greater contrast to the moisture indicator against which the moisture indicator can be read more easily.

### BRIEF DESCRIPTION OF THE DRAWINGS

The invention will be described in the following purely by way of example with reference to possible embodiments and to the enclosed drawings. There are shown:

FIG. 1 a sectional view of an apparatus in accordance with the invention with a sight glass and a housing wall which converges in the manner of a funnel and which engages into a connector stub of a pipe line;

FIG. 2 a sectional view of an apparatus in accordance with the invention with a sight glass and a housing wall which converges in the manner of a funnel and which engages into an opening of a pipe line;

FIG. 3 a sectional view of an apparatus in accordance with the invention with a sight glass and a housing wall which converges in the manner of a funnel and which externally engages around a connector stub of a pipe line;

FIG. 4 a sectional view of an apparatus in accordance with the invention with a sight glass and a housing wall which converges in the manner of a funnel, which engages around a connector stub of a pipe line from the outside and which has an inwardly folded over wall section in the region of the connector stub; and

FIG. 5 a sectional view of an apparatus in accordance with the invention with a sight glass and a housing wall which extends in parallel with the sight glass and which engages around a connector stub from the outside.

### DETAILED DESCRIPTION

Advantageous embodiments of the invention are described in the description, in the drawings and in the dependent claims.

In accordance with a first embodiment, a housing wall defining the second side of the housing extends at least regionally substantially in parallel with the sight glass. The second side therefore has a spacing from the sight glass which is substantially constant over the surface of the sight glass and which in turn results in a more uniform brightness in the inner housing space.

In accordance with a further embodiment, a housing wall defining the second side of the housing extends at least regionally obliquely to the sight glass. This is in particular advantageous since the housing wall can in this manner be particularly favorably configured for the flow of the refrigerant. The housing wall defining the second side of the housing can, for example, converge at least regionally toward the housing opening in the manner of a funnel.

An inner side of the housing, in particular a housing wall defining the second side, can have a reflective surface coating. Even more light is thereby radiated back into the inner housing space, which allows the inner side of the housing to appear even brighter and increases the contrast to the moisture indicator and thus even further facilitates the reading of the moisture indicator.

The surface of the moisture indicator is preferably smaller than the surface of the sight glass. It is thereby achieved that the inner housing space is also visible through the sight glass in addition to the moisture indicator. It can thus also be recognized on an inflow of the fluid into the inner housing space whether bubbles have formed in the fluid which may indicate unwanted operating states and can, for example, indicate that refrigerant is lacking or that pressure losses are occurring in a condenser.

In accordance with an embodiment, the moisture indicator can be fastened to the sight glass. Further fastening means are thereby saved and the moisture indicator directly contacts the sight glass, whereby it can be read particularly easily.

Alternatively, the moisture indicator can be fastened to a side wall and/or to a rear wall of the housing. The moisture indicator can either be fastened directly to the side wall and/or to the rear wall or can be connected thereto via fastening means, e.g. in the form of a tripod. In this respect, the fastening means do not necessarily have to be welded to the side wall or to the back wall, but can rather be clamped into the housing and urge the moisture indicator toward the sight glass. If the moisture indicator is arranged centrally in the inner housing space, e.g. by means of a holding apparatus, it can be flowed around from all sides.

In accordance with a preferred embodiment, the housing opening is arranged centrally with respect to the sight glass. A symmetrical design of the apparatus hereby results which can in particular be sensible for universal use in different flow directions of the refrigerant or with different installation positions. In addition, the apparatus can thereby be manufactured more simply and thus less expensively.

Alternatively, an eccentric arrangement of the housing opening with respect to the sight glass or a fully asymmetrical design of the apparatus is possible, e.g. to arrange the housing opening in a side wall of the housing or to position the housing opening further away from the moisture indicator by means of a prolongation of the housing.

In accordance with a further embodiment, a part of the housing defining the housing opening engages into an opening of the pipe line, in particular into an opening defined by a connector stub. This simplifies the installation of the apparatus at the pipe line since the part of the housing defining the housing opening ultimately only has to be inserted into the opening of the pipe line and to be sealingly connected to the pipe line.

Alternatively, a part of the housing defining the housing opening can externally surround an opening of the pipe line, in particular when the opening is defined by a connector stub of the pipe line. In this respect, the part of the housing defining the housing opening can be formed by a wall section folded over into the housing interior and contacting a connector stub of the pipe line from the outside.

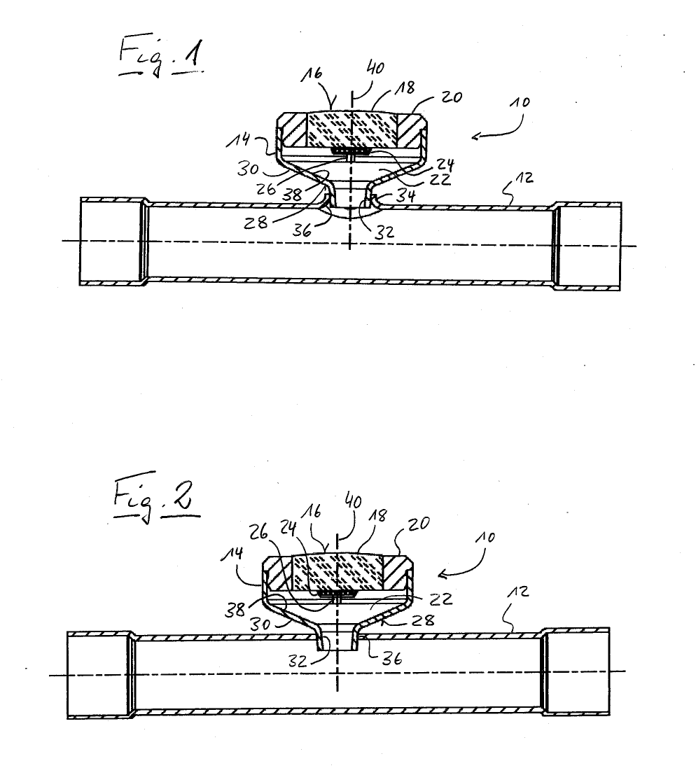

An apparatus is shown in FIG. 1 which serves for determining the moisture content of a fluid flowing through a pipe line 12, here a refrigerant of a refrigeration machine.

The apparatus 10 includes a housing 14 with a sight glass 18 and a sight glass mount 20 which define a first housing side 16.

A moisture indicator 34 which is fastened to a rear housing wall 30 by means of a moisture indicator holder 26 is located in an inner space 22 of the housing 14. The moisture indicator holder 26 includes three holding webs which each extends from the moisture indicator 24 to the rear housing wall 30 and of which in each case only one is shown in the Figures due to the selected section. The moisture indicator holder 26 is not welded to the rear housing wall 30, but is rather clamped between it and the sight glass 18.

The rear housing wall 30 forms a second housing side 28 which is disposed opposite the first housing side 16. The rear housing wall 30 furthermore bounds a housing opening 32 which has a smaller diameter than the sight glass 18 and allows an entry of the fluid flowing through the pipe line 12 into the inner housing space 22. The rear housing wall 30 converges toward the housing opening 32 in the manner of a funnel and engages into an opening 36 of the pipe line 12 defined by a connector stub 34.

The rear housing wall 30 has at its side facing the inner housing space 22 a reflective surface 38 which reflects light incident through the sight glass 18. The rear housing wall 30 thus appears brighter and forms a better contrast to the moisture indicator 24.

The surface of the moisture indicator 24 is smaller than that of the sight glass 18. This allows a view through the sight glass 18 and past the moisture indicator 24 into the inner housing space 22. In conjunction with the greater brightness in the inner housing space 22 effected by the rear housing wall 30, any bubbles which may occur in the refrigerant can easily be recognized in this manner.

The apparatus 10 is set up rotationally symmetrically about a symmetry axis 40 extending centrally through the housing opening 32 and the sight glass 18.

If refrigerant flows through the pipe line 12, a portion of the refrigerant enters through the housing opening 32 into the inner housing space 22 and interacts there with the moisture indicator 24. The moisture indicator 24 alters its color on a presence of moisture, e.g. water, in the refrigerant, which can be read off through the sight glass 18. Light incident through the sight glass 18 into the inner housing space 22 is reflected at the rear housing wall 30. This reflection, together with a comparatively flat construction of the housing, i.e. a comparatively small spacing between the rear housing wall 30 and the sight glass 18, results in a good illumination of the inner housing space 22 which in turn results in an ideal contrast between the moisture indicator 24 and the background and consequently in a particularly reliable determination of the moisture content of the refrigerant, with the additional advantage of bubble detection.

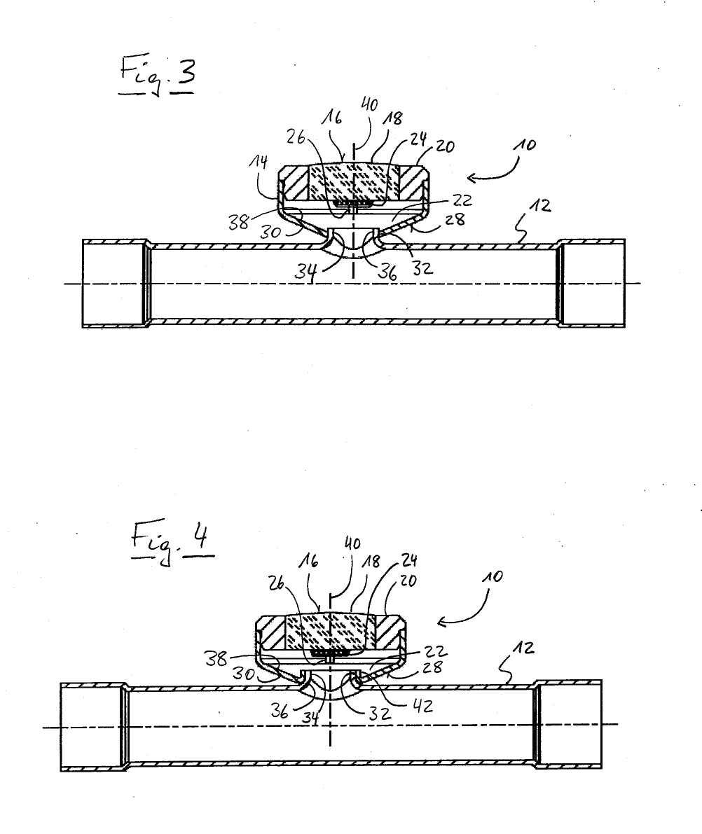

FIGS. 2 to 5 show variants of apparatus 10 which largely correspond to the above-described embodiment of FIG. 1, so that in the following only the differences between the different embodiments will be looked at. In this respect, the same reference numerals will be used for components which are identical or similar in a construction and/or functional manner.

The apparatus 10 shown in FIG. 2 only differs from the embodiment shown in FIG. 1 in that the pipe line 12 is here not equipped with a connector stub 34 for the connection of the apparatus 10, but rather only has a simple bore 36 into which the rear housing wall 30 engages.

The apparatus 10 shown in FIG. 3 differs from that shown in FIG. 1 in that a connector stub 34 of the pipe line 12 is encompassed from the outside by the rear housing wall 30. The connector stub 34 therefore projects into the inner housing space 22 of the apparatus 10.

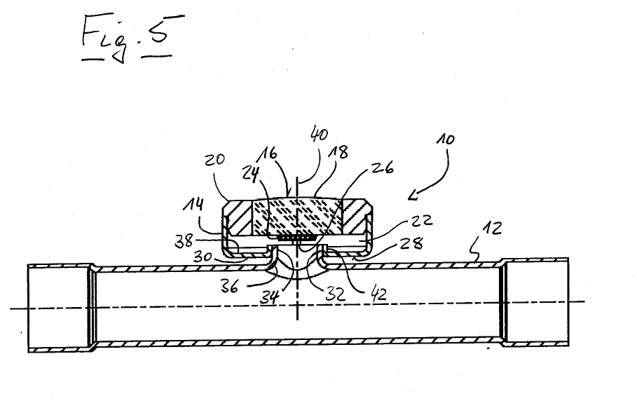

An apparatus is shown in FIG. 4 in which a connector stub 34 of the pipe line 12 is encompassed from the outside in a similar manner to the embodiment in FIG. 3. In the apparatus 10 of FIG. 4, the rear housing wall 30, however, has a wall section 42 folded over into the housing interior 22 and contacting the connector stub 34 from the outside, whereby the apparatus 10 can be sealed more easily with respect to the pipe line 12.

An apparatus is shown in FIG. 5 which only differs from that shown in FIG. 4 in that the rear housing wall 30 extends substantially in parallel with the sight glass 18. The rear housing wall 30 in other words extends at least approximately in parallel with the pipe line 12, whereby a particularly compact construction of the apparatus 10 is achieved.

### REFERENCE NUMERAL LIST

10 apparatus
12 pipe line
14 housing
16 first housing side
18 sight glass
20 sight glass mount
22 inner housing space
24 moisture indicator
26 moisture indicator holder
28 second housing side
30 rear housing wall
32 housing opening
34 connector stub
36 opening
38 surface
40 symmetry axis
42 wall section

1. An apparatus (10) for determining the moisture content of a fluid flowing through a pipe line (12), comprising
a housing (14) which defines an inner housing space (22);
a sight glass (18) arranged at a first side (16) of the housing (14);
a housing opening (32) which is arranged at a second side (28) of the housing (14), which is disposed opposite the first side (16) and which allows an entry of the fluid flowing through the pipe line (12) into the inner housing space (22); and
a moisture indicator (24) which is arranged in the inner housing space (22) visible through the sight glass (18),
wherein a dimension of the housing opening (32) is smaller in at least one direction than a dimension of the sight glass (18) in the same direction.

2. An apparatus (10) in accordance with claim 1, wherein the fluid is a refrigerant of a refrigeration machine.

3. An apparatus (10) in accordance with claim 1, wherein a housing wall (30) defining the second side (28) of the housing (14) extends at least regionally substantially parallel with the sight glass (18).

4. An apparatus (10) in accordance with claim 1, wherein a housing wall (30) defining the second side (28) of the housing (14) extends at least regionally obliquely to the sight glass (18).

5. An apparatus (10) in accordance with claim 1, wherein a housing wall (30) defining the second side (28) of the housing (14) converges at least regionally toward the housing opening (32) in the manner of a funnel.

6. An apparatus (10) in accordance with claim 1, wherein a surface of the moisture indicator (24) is smaller than the surface of a sight glass (18).

7. An apparatus (10) in accordance with claim 1, wherein the moisture indicator (24) is fastened to the sight glass (18).

8. An apparatus (10) in accordance with claim 1, wherein the moisture indicator (24) is fastened to a side wall and/or to a rear wall of the housing (14)

9. An apparatus (10) in accordance with claim 8, wherein the moisture indicator (24) is fastened by means of a holder (26) supported at the side wall and/or at the rear wall.

10. An apparatus (10) in accordance with claim 1, wherein the housing opening (32) is arranged centrally with respect to the sight glass (18).

11. An apparatus (10) in accordance with claim 1, wherein a part of the housing (14) defining the housing opening (32) engages into an opening (36) of the pipe line (12).

12. An apparatus (10) in accordance with claim 11, wherein the opening is defined by a connector stub (34).

13. An apparatus (10) in accordance with claim 1, wherein a part of the housing (14) defining the housing opening (32) surrounds an opening (36) of the pipe line (12) from the outside.

14. An apparatus (10) in accordance with claim 13, wherein the opening is defined by a connector stub (34).

15. An apparatus (10) in accordance with claim 13, wherein the part of the housing (14) defining the housing opening (32) is formed by a wall section which is folded over into the housing interior (22) and which contacts a connector stub (34) of the pipe line (12) from the outside.
